(19) United States
(12) Patent Application Publication
(10) Pub. No.: US 2005/0006862 A1
(43) Pub. Date: Jan. 13, 2005

(54) Cart for operating lawn equipment

(76) Inventor: Marvin Courson, Ft. Myers, FL (US)

Correspondence Address: HAHN LOESER & PARKS, LLP, One GOJO Plaza, Suite 300, AKRON, OH, 44311-1076, US

(21) Appl. No.: 10/617,877

(22) Filed: Jul. 11, 2003

(51) Int. Cl. B62B 1/00

(52) U.S. Cl. 280/47.17

(57) ABSTRACT

A novel cart for carrying lawn equipment during operation, in particular lawn trimmers (e.g. WEEDEATERS) is disclosed herein. Aspects of the inventive cart include a debris guard for preventing lawn debris generated by the lawn trimmer from striking the operator, a throttle assembly for operating the lawn equipment, and a mounting device for carrying the fuel tank of the lawn equipment.

### BACKGROUND AND SUMMARY OF THE INVENTION

The present invention is directed to a cart designed to carry and operate lawn equipment, and in particular, motorized lawn trimmers (e.g. WEEDEATERS). The present invention is particularly useful for carrying and operating fuel-powered motorized flexible line vegetation trimmers (commonly known in the art as “weed-eaters”); however, the cart of the present invention may also be used to operate electrically operated flexible line vegetation trimmers as well as other types of lawn equipment, especially lawn equipment that is relatively heavy to carry during operation. The present invention allows the operator to carry and maneuver the lawn equipment with greater ease, since most of the weight of the equipment is carried by the cart as opposed to the operator. The operator merely has to push or pull the cart along the ground.

In certain aspects of the present invention, the inventive cart has an elongated frame comprising a proximal end configured for handling by an operator. The frame further comprises a debris guard secured to the distal end of the frame, the frame being configured to carry the trimmer during operation. The cart further includes a wheel assembly secured to the frame between the handle and debris guard. The debris guard, in certain aspects, comprises an upper shield portion and a lower shield portion. The lower shield portion may be secured to the distal end of the frame and the upper shield portion may be removably or hingably secured to the lower shield portion. In addition, the upper shield portion includes an opening through which a portion of the trimmer's shaft may be enclosed, such that when the trimmer is mounted onto the cart, the shaft is secured between the upper and lower shields, and the cutting assembly of the trimmer is oriented forward of the cart. Thus, when the trimmer is mounted onto the cart and operated therefrom, the guard substantially prevents debris generated by the trimmer from blowing onto the person operating the trimmer.

In other aspects of the instant invention the cart includes a substantially U-shaped mounting device secured to the frame and configured to maintain the fuel tank of the lawn trimmer within the mounting device.

In still other aspects of the present invention, the cart includes a throttle control assembly secured to the frame, the throttle control assembly comprising an actuation device, a lever assembly, and a cable having one end secured to the actuation device and an opposite end secured to the lever assembly. Here, the lever assembly is oriented upon the frame such that when the trimmer is mounted onto the frame, at least a portion of the lever assembly is positioned near the trimmer's throttle trigger such that upon actuation of cart's throttle control assembly, the lever assembly is moved to activate the throttle trigger. Similarly, when the actuation device is released, the lever is moved away from contact with the throttle trigger.

### BRIEF DESCRIPTION OF THE FIGURES

FIG. 1 is side view of the inventive cart carrying a lawn trimmer (in phantom), with certain features of the cart reproduced in a partial exploded view.

FIGS. 2 and 3 are perspective views of the present invention showing the lawn trimmer (in phantom) next to the cart.

FIG. 4 is a side view of a second embodiment of the inventive cart carrying a lawn trimmer (in phantom), with certain features of the cart reproduced in a partial exploded view.

### DESCRIPTION OF THE EMBODIMENTS

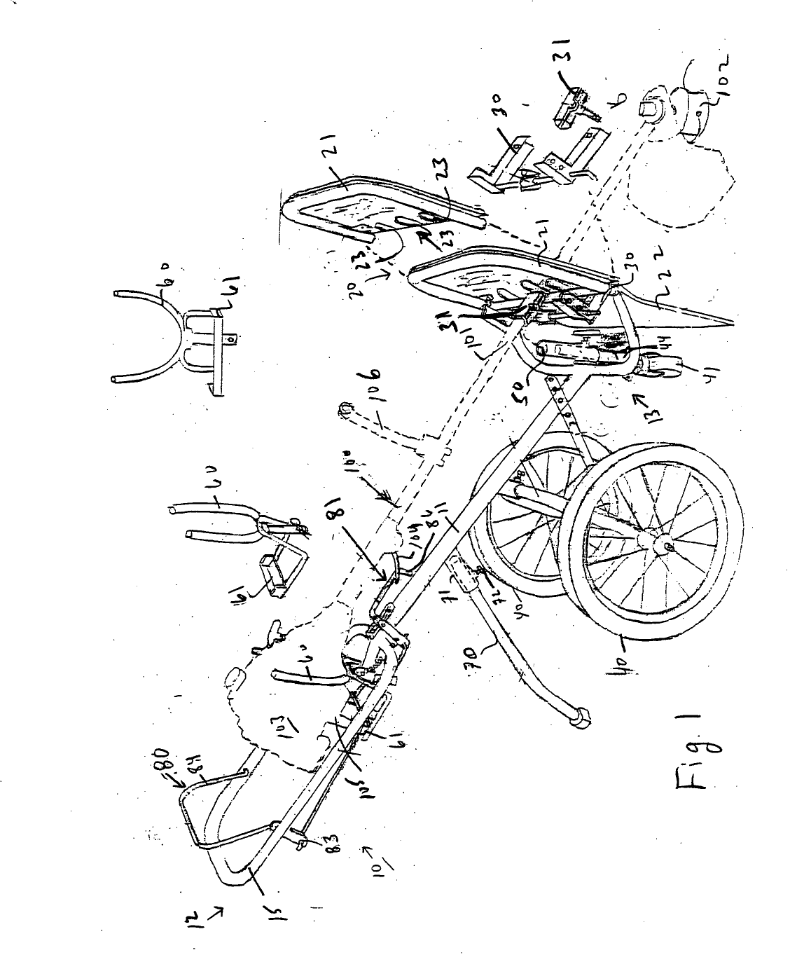

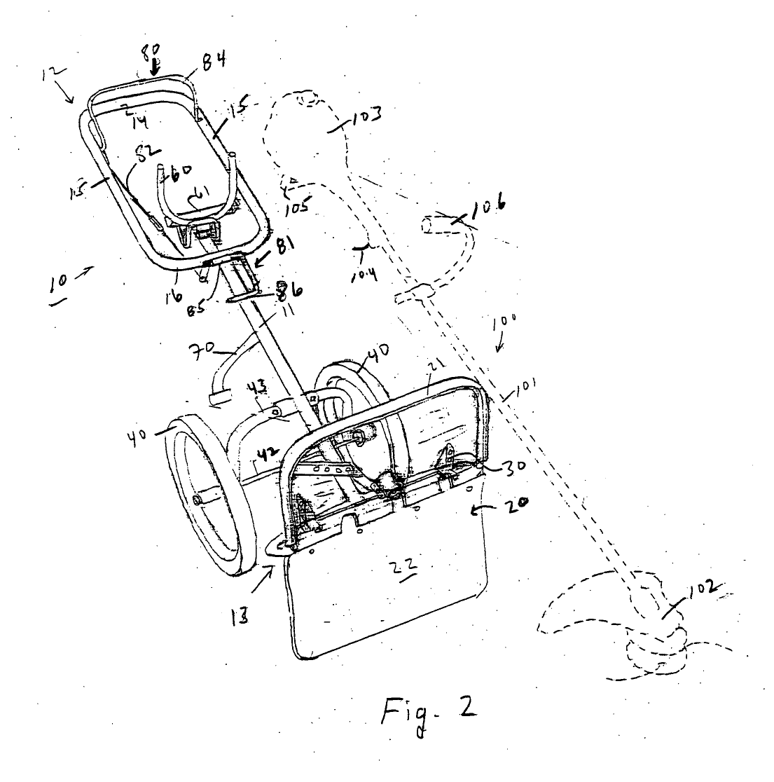

Referring now to the figures, the present invention is directed to a cart, generally denoted at 10, suitable for carrying and operating a motorized lawn trimmer, commonly known as “weedeater” in the industry (illustrated in phantom and denoted generally at 100). The cart comprises an elongated frame 11 having a proximal end 12 and a distal end 13. Secured to the frame near the distal end is a debris guard 20. In certain aspects of the invention, the debris guard comprises two portions, namely an upper shield portion 21 and a lower shield portion 22. The upper shield portion may be removably carried within a bracket assembly 30 secured to the distal end of the frame and configured to carry the lower edge of the upper portion therein. As shown in the figures, the upper shield portion of the debris guard may have one or more openings 23 through which the trimmer's shaft 101 may be engaged. As shown in FIG. 1, the shaft 101 may be engaged within a clamp 31 secured to the bracket assembly 30 of the cart, for example. Thus, prior to placing the trimmer onto the cart, the upper shield portion 21 of the debris guard is removed and then secured into the bracket assembly 30, thereby engaging the trimmer shaft 101 therebetween.

During operation of the lawn trimmer 100, the upper shield portion, which is positioned vertically above the frame, prevents grass and other lawn debris generated by the trimmer from flying rearward and striking the operator of the equipment, in particular the operator's upper torso and face. Preferably, the upper shield portion is formed in part of a transparent plastic or glass material, thereby allowing the operator to see the operation of the trimmer (i.e. the cutting head 102) more clearly; however, if desired, the upper shield portion may be opaque. Secured beneath the upper shield portion is a lower shield portion 22 that further functions to prevent lawn debris from striking the operator, in particular the operator's legs and feet. As shown in the figures, the lower shield portion 22 may be permamently secured to the bracket assembly 30 while the upper shield portion 21 may be removably secured to the bracket assembly. It will be appreciated by those of ordinary skill in the art, however, that the debris guard may be configured such that the lower shield portion is removably secured to the frame. In addition, the upper and lower shield portions could be one contiguous sheet (with or without the central bracket assembly 30 as shown), with the upper shield portion having a separate means for allowing insertion of the cutting end 102 of the trimmer therethrough. The upper shield portion could also be hingably secured to the lower shield portion at one end, thereby enabling the upper shield portion to swing open to allow placement of the lawn trimmer therebetween. Alternatively, the upper shield portion could be partially removeable, such that the lawn trimmer could be inserted through the gap existing between the upper and lower shield portions. These and other variations to the debris guard may be employed without departing from the spirit of the invention.

Secured to the frame are a set of wheels, preferably a fixed pair of larger wheels 40 and a smaller, rotatable wheel 41 oriented forward of the pair of wheels 40. The larger wheels 40 are secured to one another by an axle 42, which in turn, is secured to a bracket 43. The bracket 43 is secured to the frame of the cart as shown. The smaller wheel 41 of the cart aids in maneuvering the cart right and left during operation of the lawn equipment carried thereon. In some aspects of the invention, the smaller wheel 41 may be a secured to a post 44 that in turn is engaged within a tube 50 extending from the frame to thereby allow for height adjustment of the wheel 41 therein. While the present invention requires some type of wheel or roller assembly for purposes of moving the cart, it will be readily appreciated by those of ordinary skill in the art that the number, configuration, and size of the wheel assembly is not critical to the operation of the cart.

The lawn equipment 100 illustrated in the figures is a conventional gasoline-powered lawn trimmer, comprising in part a central handle 106 as well as a proximal handle 105 which may be grasped by the operator for ease of operation. The lawn equipment may also comprise a combination motor/fuel tank assembly 103. As described herein and referenced in the claims of the invention, “motor/fuel tank assembly” means a combination motor/fuel tank as illustrated herein as well as just the motor alone (i.e. separated somewhat from the fuel tank in equipment having a fuel tank) or just the fuel tank alone (i.e. separated somewhat from the motor). “Motor/fuel tank assembly” also includes just the motor alone in lawn equipment which do not employ a fuel tank, namely electrically-operated equipment.

The cart 10 of the present invention is particularly useful in operating and carrying these gasoline-operated lawn trimmers, as illustrated herein and described above, since such trimmers can be particularly heavy and cumbersome to operate due in part to those trimmers having a motor/fuel tank assembly 103, similar to that illustrated herein, which is often located near the proximal end of the trimmer. The motor/fuel tank assembly 103 of the trimmer 100 illustrated herein is located at the proximal-most end of the trimmer. To help stabilize and maintain the trimmer within the cart, the cart may further include a substantially U-shaped mounting device 60 secured to the frame of the trimmer. The mounting device 60 is sufficiently sized to cradle the motor/fuel tank assembly 103 therein (or the motor alone or the fuel tank alone in other lawn equipment designs, as discussed above). To add further support, the mounting device may include a small bracket 61 for maintaining the proximal handle 105 of the trimmer (for those models having such a handle). It will be appreciated by the skilled artisan, however, that the inventive cart may be designed such that the mounting device is positioned further forward or rearward along the frame to accommodate other types of lawn equipment, in particular lawn equipment having a motor and/or fuel tank secured elsewhere upon the equipment.

For purposes of supporting the cart in a somewhat upright or angled position relative to the ground when the cart is stationary, a support leg 70 may be employed, as better shown in FIG. 1. The support leg 70 may be housed in a tube portion 71 extending from the frame, as shown in FIG. 1. The height of the support leg may be adjusted by locking one end of the leg within the tube via a locking screw 72, for example. It will be recognized by the skilled artisan, however, that other conventional means may be employed for adjusting the height of the support leg.

Certain aspects of the present invention may also include a novel throttle control assembly secured to the frame. The throttle assembly comprises an actuation device 80, a lever assembly 81, and a cable 82 having one end secured to the actuation device and an opposite end secured to the lever assembly. The lever assembly, as shown in the figures, is oriented on the frame such that when the trimmer is mounted onto the frame, at least a portion of the lever assembly is positioned near the trimmer's throttle trigger 104 such that upon actuation of the throttle control assembly of the cart, the lever assembly is moved to contact, and thereby activate, the trigger. Similarly, when the actuation device is released, the lever is moved away from contact with the throttle trigger, thereby allowing the motor to idle.

The figures illustrate a preferable design of the throttle assembly, wherein the proximal end of the frame comprises a substantially rectangular frame portion. The frame portion further includes an upper horizontal handle 14 integral with two side bars 15 and a lower bar 16 integral with the same two side bars.

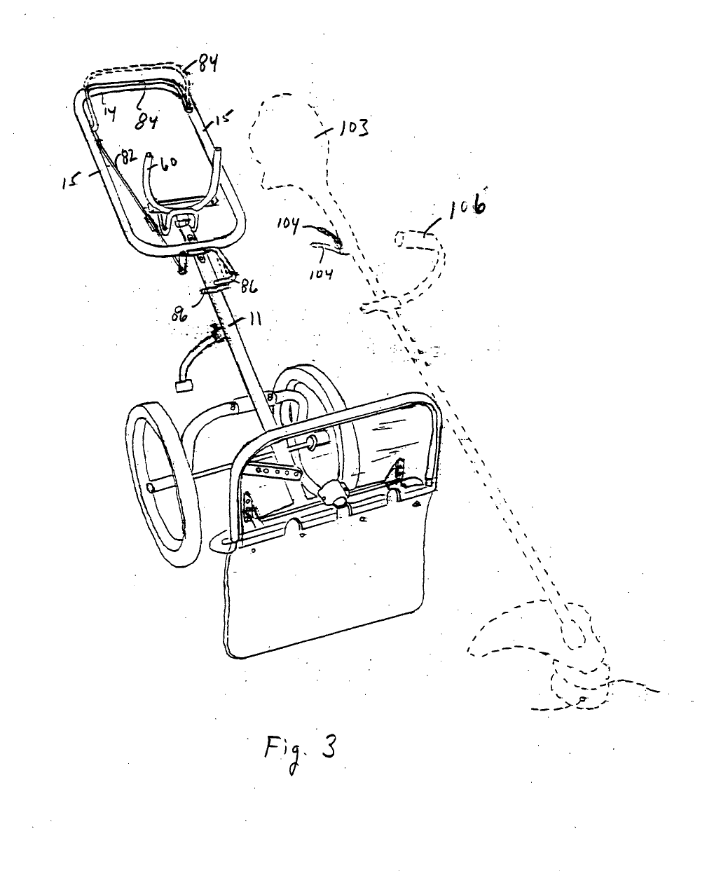

The figures also illustrate a preferred design of the throttle assembly, as described in part above. Here, the actuation device 80 may include a horizontal handle 84 hingably secured to the side bar 83. The lever assembly 81 is secured to the frame upon or near the lower bar 16. As illustrated, the lever assembly 81 may also include a fixed hinged end 85 secured to the frame and to said cable 82 and a freely movable end 86 that contacts and moves the throttle trigger 104 when the handle 84 is depressed against the frame handle (i.e. upper bar 14). FIG. 3 illustrates the handle 84 in the depressed position (in bold lines) to actuate the throttle trigger 104 (shown in bold lines) of the lawn trimmer. When the handle 84 is released, the freely movable end 86 of the lever assembly is moved away from contact with the throttle trigger 104, thereby allowing the motor of the lawn equipment to idle. FIG. 3 illustrates the handle 84 (in phantom lines) in the released position to release the trigger throttle 104 (in phantom lines).

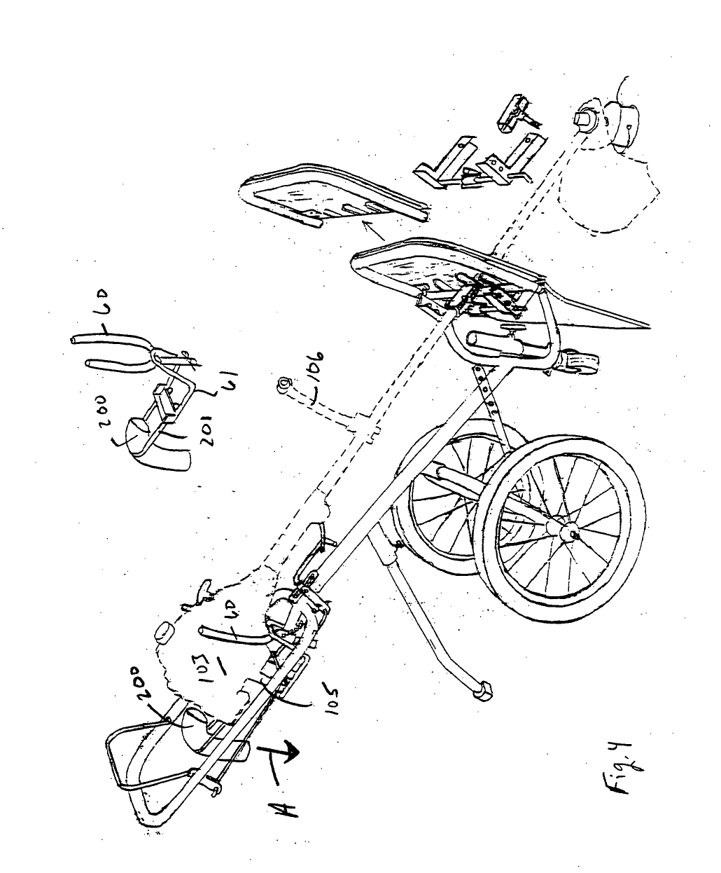

FIG. 4 illustrates a second embodiment of the present invention, wherein a fuel exhaust diversion pipe 200 is provided. As shown in FIG. 4, the pipe 200 is secured near the proximal end of the frame, just behind the motor/fuel tank assembly 103. The pipe 200 may be mounted to the cart via an additional mounting bracket 201 secured to the U-shaped mounting device 60 of the cart. The pipe 200 is preferably positioned upon the cart such that upon operation of the motor, the fuel exhaust emanating from the motor is diverted away from the operator of the cart. A preferable design is illustrated in FIG. 4, wherein the pipe has an elbow shape and is positioned such that the fuel exhaust is diverted downward toward the ground, in the direction of arrow A.

The components of the inventive cart may be formed of any number of durable materials known in the art. The figures illustrate a preferred embodiment of the present invention, wherein the cart includes all of the features described above (e.g. debris guard, throttle assembly, U-shaped motor mounting device, support leg, etc.); however, it will be appreciated that the cart may employ less than all of these features or additional features.

While the inventive cart is particularly advantageous for use in operating relatively heavy gasoline powered lawn trimmers, it will be appreciated by the skilled artisan that electrically powered lawn trimmers as well as other types of lawn and garden equipment (gasoline or electrically powered) may be used, including, but not limited to, lawn edgers, blowers, and other “weedeater” designs.

1. A cart suitable for carrying and operating a motorized lawn trimmer, said trimmer having a motor/fuel tank assembly, an elongated shaft, and a cutting assembly, said cart comprising:
a. an elongated frame comprising a proximal end and a distal end, said proximal end configured for handling by an operator of said cart, said frame further comprising a debris guard secured to said distal end, wherein said frame is configured to carry said trimmer during operation of said trimmer;
b. a wheel assembly secured to said frame between said handle and said debris guard; and
c. said debris guard comprising an upper shield portion and a lower shield portion, wherein said upper shield portion further comprises an opening through which a portion of said trimmer shaft may be housed, such that when said trimmer is mounted onto said cart, said shaft is secured between said upper and lower shields and said cutting assembly of said trimmer is oriented forward of said cart;
whereby when said trimmer is mounted onto said cart and operated therefrom, said guard substantially prevents debris generated by said trimmer from blowing onto an operator of said trimmer.

2. The cart of claim 1, said cart further comprising a substantially U-shaped mounting device secured to said frame and configured to maintain said motor/fuel tank assembly of the lawn trimmer within said mounting device.

3. The cart of claim 1, wherein said lower shield portion is secured to said distal end of said frame and said upper shield portion is removably secured to said lower shield portion.

4. The cart of claim 1, further including an exhaust pipe secured to said cart near said motor/fuel tank assembly, such that upon actuation of said motor/fuel tank assembly, fuel exhaust emanating from said motor/fuel tank assembly is diverted through said pipe.

5. The cart of claim 4, wherein said pipe is configured to divert said fuel exhaust downward below said cart frame.

6. The cart of claim 1, wherein said upper shield portion is formed of a substantially transparent material, such that at least a portion of said cutting assembly of said trimmer may be viewed through said upper shield portion by said operator during operation of said trimmer.

7. The cart of claim 1, said cart further including an elongated support leg secured to said frame between said proximal and distal ends.

8. The cart of claim 1, wherein said wheel assembly includes (a) a first pair of wheels secured to one another by an axle and a bracket, said bracket further secured to said frame, and (b) a third wheel rotatably secured to said frame between said first pair of wheels and said debris guard.

9. A cart suitable for carrying and operating a motorized lawn trimmer, said trimmer having a motor/fuel tank assembly, an elongated shaft, and a cutting assembly, said cart comprising:
a. an elongated frame comprising a proximal end and a distal end, said proximal end configured for handling by an operator of said cart, said frame further comprising a debris guard secured to said distal end, wherein said frame is configured to carry said trimmer during operation of said trimmer;
b. a wheel assembly secured to said frame between said handle and said debris guard; and
c. a substantially U-shaped mounting device secured to said frame and configured to maintain a fuel tank of the lawn trimmer within said mounting device.

10. The cart of claim 9, wherein said debris guard comprises an upper shield portion and a lower shield portion, wherein said upper shield portion further comprises an opening through which a portion of said trimmer shaft may be housed, such that when said trimmer is mounted onto said cart, said shaft is secured between said upper and lower shields and said cutting assembly of said trimmer is oriented forward of said cart; whereby when said trimmer is mounted onto said cart and operated therefrom, said guard substantially prevents debris generated by said trimmer from blowing onto an operator of said trimmer.

11. The cart of claim 10, wherein said upper shield portion is formed of a substantially transparent material, such that at least a portion of said cutting assembly of said trimmer may be viewed through said upper shield portion by said operator during operation of said trimmer.

12. A cart suitable for carrying and operating a motorized lawn trimmer, said trimmer having a motor/fuel tank assembly, an elongated shaft, and a cutting assembly, said cart comprising:
a. an elongated frame comprising a proximal end and a distal end, said proximal end configured for handling by an operator of said cart, said frame further comprising a debris guard secured to said distal end, wherein said frame is configured to carry said trimmer during operation of said trimmer;
b. a wheel assembly secured to said frame between said handle and said debris guard; and
c. a throttle control assembly secured to said frame, said throttle assembly comprising a actuation device, a lever assembly, and a cable having one end secured to said actuation device and an opposite end secured to said lever assembly, said lever assembly oriented on said frame such that when said trimmer is mounted onto said frame, at least a portion of said lever assembly is positioned near a throttle trigger of said trimmer such that upon actuation of said throttle control assembly of said cart, said lever assembly is moved to contact said throttle trigger to activate said trigger, and when said actuation device is released, said lever is moved away from contact with said throttle trigger.

13. The cart of claim 12, said proximal end comprising a substantially rectangular frame portion, said rectangular frame portion comprising an upper horizontal handle integral with two side bars and a lower bar integral with said side bars; said actuation device comprising a horizontal handle hingably secured to said side bars, and wherein said lever assembly is secured to said frame upon or near said lower bar, said lever assembly having (i) a fixed hinged end secured to said frame and to said cable and (ii) a freely movable end that contacts and moves said throttle trigger when said handle of said actuation device is moved to contact said handle of said frame and releases said trigger when said handle is released.

14. The cart of claim 12, wherein said debris guard comprises an upper shield portion and a lower shield portion, wherein said upper shield portion further comprises an opening through which a portion of said trimmer shaft may be housed, such that when said trimmer is mounted onto said cart, said shaft is secured between said upper and lower shields and said cutting assembly of said trimmer is oriented forward of said cart; whereby when said trimmer is mounted onto said cart and operated therefrom, said guard substantially prevents debris generated by said trimmer from blowing onto an operator of said trimmer.

15. The cart of claim 14, wherein said lower shield portion is secured to said distal end of said frame and said upper shield portion is removably secured to said lower shield portion.

16. The cart of claim 12, further including an exhaust pipe secured to said cart near said motor/fuel tank assembly, such that upon actuation of said motor/fuel tank assembly, fuel exhaust emanating from said motor/fuel tank assembly is diverted through said pipe.

17. The cart of claim 16, wherein said pipe is configured to divert said fuel exhaust downward below said cart frame.

18. A cart suitable for carrying and operating a motorized lawn trimmer, said trimmer having a motor/fuel tank assembly, an elongated shaft, and a cutting assembly, said cart comprising:
a. an elongated frame comprising a proximal end and a distal end, said proximal end configured for handling by an operator of said cart, said frame further comprising a debris guard secured to said distal end, wherein said frame is configured to carry said trimmer during operation of said trimmer;
b. a wheel assembly secured to said frame between said handle and said debris guard;
c. a throttle control assembly secured to said frame, said throttle assembly comprising a actuation device, a lever assembly, and a cable having one end secured to said actuation device and an opposite end secured to said lever assembly, said lever assembly oriented on said frame such that when said trimmer is mounted onto said frame, at least a portion of said lever assembly is positioned near a throttle trigger of said trimmer such that upon actuation of said throttle control assembly of said cart, said lever assembly is moved to contact said throttle trigger to activate said trigger, and when said actuation device is released, said lever is moved away from contact with said throttle trigger;
d. a substantially U-shaped mounting device secured to said frame and configured to maintain said motor/fuel tank assembly of the lawn trimmer within said mounting device; and
e. said debris guard comprising an upper shield portion and a lower shield portion, wherein said upper shield portion further comprises an opening through which a portion of said trimmer shaft may be housed, such that when said trimmer is mounted onto said cart, said shaft is secured between said upper and lower shields and said cutting assembly of said trimmer is oriented forward of said cart;
whereby when said trimmer is mounted onto said cart and operated therefrom, said guard substantially prevents debris generated by said trimmer from blowing onto an operator of said trimmer.

19. The cart of claim 18, further including an exhaust pipe secured to said cart near said motor/fuel tank assembly, such that upon actuation of said motor/fuel tank assembly, fuel exhaust emanating from said motor/fuel tank assembly is diverted through said pipe.

20. The cart of claim 19, wherein said pipe is configured to divert said fuel exhaust downward below said cart frame.
